(19) United States
(12) Patent Application Publication
(10) Pub. No.: US 2025/0284413 A1
(43) Pub. Date: Sep. 11, 2025

(54) STARTING OF A MEMORY

(71) Applicant: STMicroelectronics International N.V., Geneva (CH)

(72) Inventors: Guillaume DOCQUIER, Waremme (BE); Michael PEETERS, Tourinnes-la-Grosse (BE)

(73) Assignee: STMicroelectronics International N.V., Geneva (CH)

(21) Appl. No.: 19/071,184

(22) Filed: Mar. 5, 2025

(30) Foreign Application Priority Data
Mar. 8, 2024 (FR) FR2402336

(51) Int. Cl. G06F 3/06

(52) U.S. Cl. CPC G06F 3/0623; G06F 3/0652; G06F 3/0659; G06F 3/0679

(57) ABSTRACT

A method of verifying writing of data into a memory includes a step of verifying whether a last group of data written into the memory includes at least one sensitive data item. When the last group of data includes at least one sensitive data item, a first group of data is erased from the memory. At least one address of that first group of data is indicated in at least one first metadata item of a data item of said last group of data.

### PRIORITY CLAIM

This application claims the priority benefit of French Application for Patent No. 2402336, filed on Mar. 8, 2024, the content of which is hereby incorporated by reference in its entirety to the maximum extent allowable by law.

### TECHNICAL FIELD

The present disclosure generally concerns electronic systems and devices and, more particularly, the storage of data by electronic systems and devices. The present disclosure more specifically concerns a method of writing data into a memory, and an associated method of starting a memory.

### BACKGROUND

It is very common to store data in a memory of an electronic system or device. When these data comprise sensitive data, such as secret data, it is important to make sure that all the steps linked to the data writing and erasing method have effectively been carried out.

It would be desirable to be able to improve, at least partly, certain aspects of methods for storing data into a memory.

There exists a need for more secure methods of writing into a memory.

There exists a need for methods of starting a memory enabling to verify the correct completion of the last write operation performed.

There exists a need for method of storing sensitive information which guarantee an effective erasing of these data.

There exists a need for method of starting a memory enabling to detect a power-off attack.

There exists a need for electronic devices implementing such methods.

There exists a need to overcome all or part of the disadvantages of known methods of writing into a memory.

There exists a need to overcome all or part of the disadvantages of known memory starting methods.

### SUMMARY

An embodiment provides a method of writing a group of data into a memory, wherein the last group of data written into the memory only comprises non-sensitive data.

An embodiment provides a memory starting method wherein it is verified whether the last group of data written into the memory comprises at least one sensitive data item.

An embodiment provides a memory starting method wherein, if the last written group of data comprises a sensitive data item, an operation of erasing of the last copy of said group of data is implemented.

An embodiment further provides, after the implementation of an erase operation during the starting method, the implementation of an operation of writing of a group of data only comprising non-sensitive reference data following the last written group of data.

An embodiment provides a method of verifying the writing of data into a memory, comprising the following successive steps: verifying whether the last group of data written into the memory comprises at least one sensitive data item; and when said group comprises at least one sensitive data item, erasing a first group of data, at least one address of which is indicated in at least one first metadata item of a data item of said last group of data.

Another embodiment provides an electronic device comprising a memory, configured to implement a method of verifying the writing of data into said memory comprising the following successive steps: verifying whether the last group of data written into the memory comprises at least one sensitive data item; and when said group comprises at least one sensitive data item, erasing a first group of data, at least one address of which is indicated in at least one first metadata item of a data item of said last group of data.

According to an embodiment, the erasing step is followed by a step of writing of a second group of data only comprising non-sensitive reference data.

According to an embodiment, if said group comprises no sensitive data item, no erasing step is implemented.

According to an embodiment, said memory is a non-volatile memory.

According to an embodiment, each data item comprises a second metadata item indicating whether the data item is sensitive or non-sensitive.

According to an embodiment, each data item comprises a third metadata item indicating the validity of said data item.

According to an embodiment, each data item comprises a fourth metadata item indicating whether the data item is a last data item of a group of data.

According to an embodiment, the method of verification of the writing of data into said memory is implemented at the starting of said memory.

According to an embodiment, the method of verification of the writing of data into said memory is implemented prior to a phase of writing of data into said memory.

According to an embodiment, the memory is a non-volatile memory.

According to an embodiment, at each writing of groups of data, the last group of data to be written only comprises non-sensitive data.

Another embodiment provides a method of starting an electronic device comprising said memory comprising the previously-described starting method.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 shows, very schematically and in the form of blocks, an electronic device configured to implement the implementation modes described in relation with FIGS. 2 to 4;

FIG. 2 shows a block structure of a data item to be stored in a memory;

FIG. 3 shows a block diagram illustrating an implementation mode of a method of writing data into a memory; and

FIG. 4 shows a block diagram illustrating an implementation mode of a memory starting method.

### DETAILED DESCRIPTION

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings.

Unless specified “about”, “approximately”, “substantially”, and “in the order of” signify plus or minus 10%, preferably of plus or minus 5%.

The embodiments described hereafter concern the storage of data into a memory, and more particularly, a method of writing data into a memory enabling to detect a power-off attack. More specifically, the present disclosure relates to an implementation mode of a method of writing groups of data into a memory, in which the last group of data written into the memory only comprises non-sensitive data, that is, comprises no sensitive data. The present disclosure further concerns an implementation mode of a memory starting method in which it is verified whether the last group of data written into the memory is exclusively formed of non-sensitive data, and optionally remedies this if such is not the case.

Further, the embodiments described hereafter are particularly adapted to any type of application using the storage of data into a memory, and in particular the storage of sensitive and non-sensitive data into a memory.

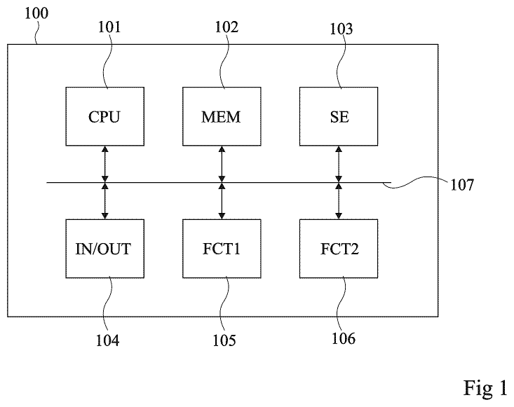

FIG. 1 is a block diagram very schematically showing an architecture of an example of an electronic device 100 configured to implement a memory starting method.

Electronic device 100 comprises a processor 101 (CPU) configured to implement several processing of data stored in memories and/or supplied by other circuits of device 100. According to an embodiment, processor 101 is configured to implement a memory starting method.

Electronic device 100 further comprises different types of memories 102 (MEM), among which, for example, a non-volatile memory, a volatile memory, and/or a read-only memory. Each memory 102 is configured to store different types of data. According to an embodiment, device 100 comprises at least one non-volatile memory configured to store sensitive data and non-sensitive data. According to a preferred embodiment, memory 102 is a non-volatile memory.

Electronic device 100 further comprises, for example, a secure element 103 (SE) configured to manipulate sensitive and/or secret data. Secure element 103 may comprise its own processor(s), its own memory or memories, etc. According to an embodiment, secure element 101 is configured to implement a memory starting method.

Electronic device 100 may further comprise interface circuits 104 (IN/OUT) configured to send and/or to receive data originating from the outside of device 100. Interface circuits 104 may further be configured to implement a data display, for example, a display screen.

Electronic device 100 further comprises different circuits 105 (FCT1) and 106 (FCT2) configured to perform different functions. As an example, circuits 105 and 106 may comprise measurement circuits, data conversion circuits, etc. According to an embodiment, circuits 105 and 106 may comprise a circuit configured to implement a memory starting method.

Electronic device 100 further comprises one or a plurality of data buses 107 configured to transfer data between its different components.

According to a specific example, electronic device 100 is configured to implement computer programs, and in particular a computer program enabling to implement a memory starting method.

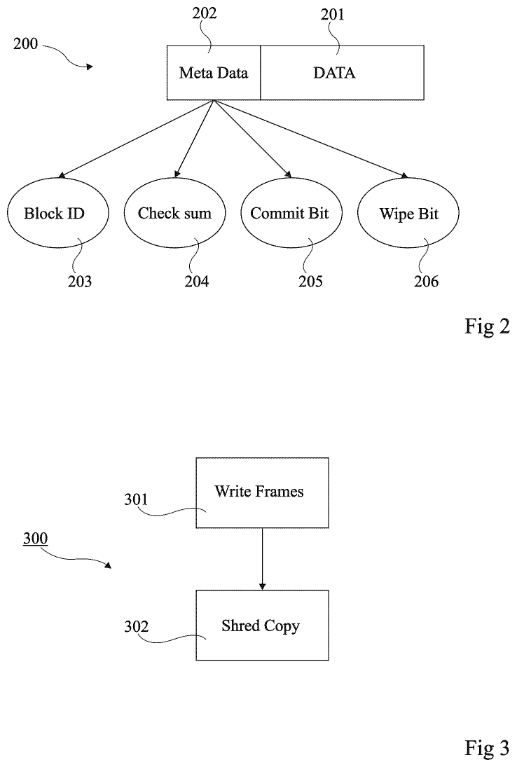

FIG. 2 shows, very schematically and in the form of blocks, a data item 200 configured to be stored in one of the memories 102 of the device 100 described in relation with FIG. 1. More particularly, data item 200 is configured to be stored in the non-volatile memory of device 100. According to an embodiment, memory 102 is a non-volatile memory.

According to an embodiment, data item 200 is made up of its content 201 (DATA) and of metadata 202 (Metadata) enabling to characterize data item 200.

The content 201 of data item 200 represents the actual information carried by data 200.

Metadata 202 comprise a plurality of metadata items, each representing a characteristic of data 200. According to an example, each metadata item of metadata 202 is one or a plurality of data bits.

According to an embodiment, metadata 202 comprise an identification metadata item 203 (Block ID) enabling a data manager to find all the copies of a same data item written into the memory. In other words, all copies of a same data item have the same addressing metadata item 203. According to an embodiment, addressing metadata item 203 enables, during the writing of data item 200 into the memory, to launch an operation of erasing of the previous copy or copies of data item 200 already written in the memory. Other uses of metadata item 203 are within the abilities of those skilled in the art. According to an example, metadata item 203 is a word of a plurality of data bits.

According to an example, metadata 202 comprise a write verification metadata item 204 (Checksum) which indicates whether the content 201 of data item 200 has been written correctly. In other words, metadata item 204 may enable to verify whether the operation of writing of data item 200 has occurred and/or whether it has occurred correctly. This metadata item 204 is always written at the end of the method of writing into the memory of data item 200. According to an example, metadata item 204 is a word of a plurality of data bits. According to another example, metadata item 204 is a single data bit.

According to an example, metadata 202 comprise an end-of-writing metadata item 205 (Commit Bit) indicating whether data item 200 is the last data item of a group of data being written. Indeed, it is uncommon to write into a memory only one data item at a time. It is more common to write data in groups into the memory. Thus, if end-of-writing metadata item 205 indicates that data item 200 is the last data item in a group of data to be written, this means that all the other data in the group have been written into the memory. According to an example, metadata item 205 is a single data bit.

According to an embodiment, metadata 202 comprise a metadata item 206 (Wipe Bit) indicating whether data item 200 is a sensitive or non-sensitive data item. With reference to “sensitive data” type data, this is understood to mean and refers to data the content of which is not intended to be accessible to the public. According to an example, secret data are sensitive data. Thus, if metadata item 206 indicates that data item 200 is a sensitive data item, this means that the content 201 of data item 200 comprises one or a plurality of sensitive pieces of information. Conversely, if metadata item 206 indicates that data item 200 is a non-sensitive data item, this means that the content 201 of data item 200 comprises no sensitive information. According to an example, metadata item 206 is a single data bit.

It should be noted that, according to an embodiment, a group of data to be written into a memory may comprise sensitive and/or non-sensitive data.

FIG. 3 is a block diagram illustrating an example of a method of writing groups of data into memory 300.

According to an embodiment, method 300 concerns the writing into a memory, of the type of a memory 102 of the device 100 described in relation with FIG. 1, of one or a plurality of groups of data of the type of the data item 200 described in relation with FIG. 2.

At an initial step 301 (Write Frames), all the data in the group(s) of data to be written are written into the memory. According to an example, the data of each group of data are written sequentially into the memory, that is, one at a time, and one after the other.

At a step 302 (Shred Copy), successive to step 301, the last copy of the group of data written in the memory is erased. For this purpose, the addressing metadata 203 of the data are used. In other words, the data designated by the addresses of the addressing metadata 203 of the data of the group of data are all erased. According to an example, an erasing step may be an erasing step, that is, a step of destruction of the written data item, or may be a step of rewriting of another data item over the data item already written.

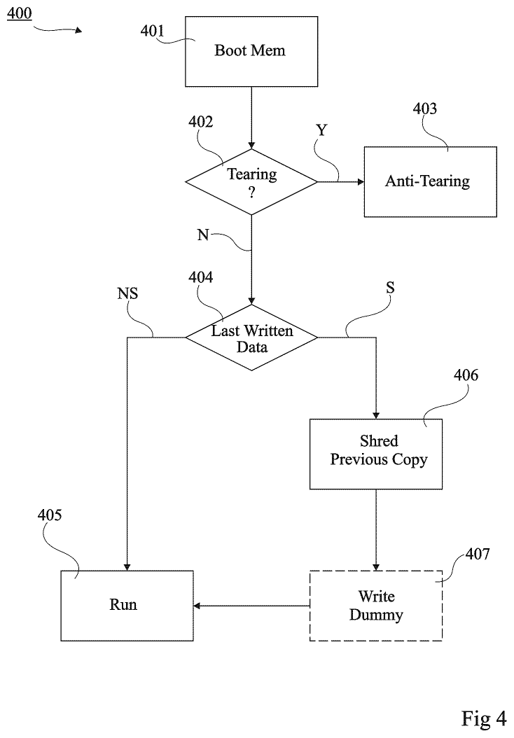

A disadvantage of this method of writing into a memory is that if a power-off attack is carried out between steps 301 and 302, old copies of sensitive data may happen not to be correctly removed. The starting method described in relation with FIG. 4 enables to overcome this disadvantage.

FIG. 4 is a block diagram illustrating an implementation mode of a method 400 of starting a memory in which groups of data, of the type of the data item 200 described in relation with FIG. 2, have been written, by using the method of writing into a memory 300 described in relation with FIG. 3.

At an initial stage 401 (Boot Mem), the memory is started. According to an embodiment, this memory is of the type of one of the memories 102 described in relation with FIG. 1, for example a non-volatile memory. This starting step may form part of a method of starting a device comprising the memory, such as the device 100 of FIG. 1.

At a step 402 (Tearing?), successive to step 401, the memory, or an ancillary circuit, may implement a verification of the last group of data written into the memory to verify whether this last writing step has been carried out entirely and/or correctly. This step 402 enables to verify whether the step 301 of FIG. 3 has been carried out correctly or not. For this purpose, a metadata item of the type of the metadata item 204 of the last written data item may be verified. If this verification indicates a problem (output Y of block 402), a step 403 (Anti-tearing) is implemented, otherwise (output N of the block, a step 404 (Last Written Data) is implemented.

At step 403, it has been detected that the last write operation could not be completed entirely and/or correctly. A data rewrite and/or recovery operation may be implemented. Such operations are within the abilities of those skilled in the art. This step may either cancel the rest of the starting method, or may be followed by the step 406 described hereafter.

At step 404 (Last Written Data?), successive to step 402, a verification is made as to whether the last data written into the memory has been written correctly and/or entirely. It is here verified whether the last group of data written into the memory comprises or not sensitive data. What is referred to here as the last group of data written into the memory means and the last group of data which has been written into the memory before its stopping. In other words, the last group of data written into the memory is the group of data for which the write operation is the most recent. This last group may be indicated by the value of a metadata item of the type of the metadata item 205 described in relation with FIG. 2, or be indicated by its location in the memory.

If the last written group of data only comprises non-sensitive data (output NS of block 404), the next step is a step 405 (Run). If the last written group of data comprises at least one sensitive data item (output S of block 404), the next step is a step 406 (Shred Previous Copy).

Where step 405 is reached, the last group of data written into the memory only comprises non-sensitive data, indicating that the last operation of writing of a group of data has been performed smoothly. The memory can thus be used, without performing other operations, and in particular without previously performing other erase operations.

Where step 406 is reached, the last written into the memory comprises at least one sensitive data item, indicating that there is a risk that the last operation of writing of a group of data into the memory has been stopped before being completed. This would thus indicate that the operation of erasing of the last copy of the recently written groups of data may not have been completed. In this case, an erase operation of the type 302 is performed. In other words, the last copy of at least the last group of data written to memory is erased, by using for this purpose the addressing metadata 203 of the data in the group. Still in other words, the data designated by the addresses of the metadata of the data of the last written group of data are all erased.

In an optional step 407 (Write Dummy), successive to step 406, a group of data comprising only non-sensitive reference data is written after the last group of data written before the stopping of the memory. This enables to avoid a new erase operation if the memory is stopped again without for any other data item to have been written after the data item tested at step 404.

The step following step 407 is step 405. If step 407 does not take place, step 406 is followed by step 405.

An advantage of this method is that it enables to detect that a write operation has been stopped before being completed. More particularly, this starting method enables to detect attacks such as a power-off attack, which could enable, in the present case, to access old copies of sensitive data which have not been erased yet.

Another advantage of this embodiment is that it enables to guarantee the erasing of old copies of sensitive data even after a powering off.

As previously mentioned, the method of starting the memory may be integrated in a method of starting an electronic device comprising said memory.

Various embodiments and variants have been described. Those skilled in the art will understand that certain features of these various embodiments and variants may be combined, and other variants will occur to those skilled in the art. According to an example, the verification step 404 of method 400 may further comprise a verification of the verification metadata item 204 of the last data item written into the memory.

In addition, it should be noted that the starting method may also be implemented, rather than at the starting of the memory, before a phase of writing of data into the memory. In this case, it is preferably spoken of a write verification method.

Finally, the practical implementation of the described embodiments and variants is within the abilities of those skilled in the art based on the functional indications given hereabove.

1. A method for verifying the writing of data into a memory, comprising the following successive steps:
verifying whether a last group of data written into the memory comprises at least one sensitive data item; and
when said last group comprises at least one sensitive data item, erasing a first group of data from the memory;
wherein at least an address of the first group of data is indicated in at least one first metadata item of a data item of said last group of data.

2. The method according to claim 1, further comprising, after erasing step, writing a second group of data only comprising non-sensitive reference data.

3. The method according to claim 1, wherein no erasing step is implemented when said last group of data comprises no sensitive data item.

4. The method according to claim 1, wherein said memory is a non-volatile memory.

5. The method according to claim 1, wherein each data item comprises a second metadata item indicating whether the data item is sensitive or non-sensitive.

6. The method according to claim 1, wherein each data item comprises a third metadata item indicating the validity of said data item.

7. The method according to claim 1, wherein each data item comprises a fourth metadata item indicating whether the data item is a last data item of the group of data.

8. The method according to claim 1, wherein the method of verification of the writing of data into said memory is implemented at a starting of said memory.

9. The method according to claim 1, wherein the method of verification of the writing of data into said memory is implemented prior to a phase of writing of data into said memory.

10. An electronic device comprising a memory, wherein the said electronic device is configured to implement the method of verification of the writing of data into said memory as recited in claim 1.

11. A method of writing into a memory, comprising:
verifying of the writing by:
verifying whether a last group of data written into the memory comprises at least one sensitive data item; and
when said last group of data comprises at least one sensitive data item, erasing a first group of data from the memory;
wherein at least an address of the first group of data is indicated in at least one first metadata item of a data item of said last group of data; and
wherein at each writing of groups of data, the last group of data to be written only comprises non-sensitive data.

12. A method of starting an electronic device comprising a memory, the method comprising:
verifying writing to the memory by:
verifying whether a last group of data written into the memory comprises at least one sensitive data item; and
when said last group of data comprises at least one sensitive data item, erasing a first group of data from the memory;
wherein at least an address of the first group of data is indicated in at least one first metadata item of a data item of said last group of data.
